(19) United States
(12) Patent Application Publication
(10) Pub. No.: US 2018/0286111 A1
(43) Pub. Date: Oct. 4, 2018

(54) CROSS DETERMINING PROGRAM, CROSS DETERMINING METHOD, AND CROSS DETERMINING APPARATUS

(71) Applicant: KABUSHIKI KAISHA SQUARE ENIX (also trading as SQUARE ENIX CO., LTD.), Tokyo (JP)

(72) Inventor: Yusuke TOKUYOSHI, Tokyo (JP)

(73) Assignee: KABUSHIKI KAISHA SQUARE ENIX (also trading as SQUARE ENIX CO., LTD.), Tokyo (JP)

(21) Appl. No.: 15/936,933

(22) Filed: Mar. 27, 2018

(30) Foreign Application Priority Data
Mar. 30, 2017 (JP) 2017-067594

(51) Int. Cl. G06T 15/40

(52) U.S. Cl. CPC G06T 15/40; G06T 2210/21; G06T 2210/12

(57) ABSTRACT

A non-transitory computer-readable medium including a cross determining program for causing a computer to execute processes to divide a drawing screen into a plurality of frustum bodies and determine whether each of the frustum bodies crosses an object defined and arranged in a three-dimensional virtual space or not is provided in order to determine whether the object influences on a drawing point of the drawing screen to carry out culling. The processes include: a frustum body coordinate obtaining process configured to obtain a spatial coordinate of a frustum body; an object coordinate obtaining process configured to obtain a spatial coordinate of an object; an expansion/contraction process configured to expand and contract a space in which the frustum body and the ellipsoidal body are arranged; and a cross determining process configured to carry out cross determination between the spherical body and the frustum body.

### CROSS-REFERENCE TO RELATED APPLICATION

The present application relates to subject matter contained in Japanese Patent Application No. 2017-67594 filed on Mar. 30, 2017, the disclosure of which is expressly incorporated herein by reference in its entirety.

### BACKGROUND OF THE INVENTION

### 1. Field of the Invention

At least one of embodiments according to the present invention relates to a cross determining program, a cross determining method, and a cross determining apparatus for carrying out determination of whether each frustum body when a scene to be drawn is divided into a plurality of frustum bodies crosses an object arranged in the drawn scene or not.

### 2. Description of the Related Art

In recent years, in a graphics drawing field, application of global illumination has been carried out in order to express graphics much closer to reality. Computation for the global illumination is carried out by taking into consideration optical paths from various light sources with respect to one point. For this reason, in a case where computation for all of the optical paths is carried out, an arithmetic amount becomes huge. In a real-time rendering field, there is a problem that since there is necessary to carry out the computation in real time, temporal restriction exists and there is necessary to reduce the arithmetic amount while aiming at realistic graphics.

As a method of reducing an arithmetic amount, light culling is carried out. The light culling is a method in which an influence range of light from a light source in a three-dimensional virtual space is limited to a predetermined range and an influence of the light source is ignored with respect to a point outside the predetermined range, thereby reducing the arithmetic amount.

As one of the method of the light culling, tile-based light culling (Tile-based Light Culling) exists. In the tile-based light culling, a drawing screen is divided into a plurality of tiles to set a frustum body (or frustum) for each tile, and cross determination between the frustum body and an influence range of a light source is carried out. Here, the cross determination is determination of whether a portion in which the frustum body and the influence range of the light source overlap exists or not. With respect to the light source that crosses the frustum body, an influence from the light source is computed at the time of computation of a drawing point in the tile. With respect to the light source that does not cross the frustum body, culling is carried out and the computation is omitted. Specifically, since the influence range of the light source as the object is expressed as a spherical body (bounding sphere), the light culling is carried out by the cross determination between the spherical body and the frustum body. As one in which the tile-based light culling is carried out, Non-Patent Document 1 is cited, for example.

Further, the object of the culling is not limited to only the light source. In a case where the object is an object required to compute an influence range thereof, necessity to carry out culling processing may occur. For example, in Non-Patent Document 2, execution of tile-based culling is proposed for computation of an influence range of particles.

Further, as one in which an Axis-Aligned Bounding Box (AABB) is applied to a frustum body at the time of cross determination between the frustum body and a spherical body and a computation amount is thereby reduced, Non-Patent Document 3 is cited, for example.

### PRIOR ART DOCUMENTS

[Non-Patent Document 1] Advanced Visual Effects with DirectX 11 & 12: Advancements in Tile-based Compute Rendering (http://www.gdcvault.com/play/1021764/Advanced-Visual-Effects-With-DirectX)
[Non-Patent Document 2] Advanced Visual Effects with DirectX 11: Compute-Based GPU Particle Systems (http://www.gdcvault.com/play/1020002/Advanced-Visual-Effe cts-with-DirectX)
[Non-Patent Document 3] STEWART J.: Compute-based tiled culling. In GPU Pro 6: Advanced Rendering Techniques. A K Peters/CRC Press, 2015, pp. 435-458. 1, 4

### SUMMARY OF THE INVENTION

Now, when to carry out the global illumination, for example, a vertical point light source (VPL: Virtual Point Light) is used in order to express indirect illumination such as a state that light from a light source, such as the sun, which is positioned outside a drawing range, shines on a wall surface, and the wall surface and the vicinity thereof become bright, and the like. The indirect illumination is expressed by a method in which a plurality of VPLs is arranged in the wall surface portion, thereby showing that the wall surface reflects sunlight. As this influence range of the VPLs, the influence range has conventionally been expressed by a spherical body. However, with respect to an influence range of specular reflection, it comes to understand that global illumination much closer to reality can be carried out in a case where it is expressed by an ellipsoidal body (bounding ellipsoid) compared with the spherical body.

However, in the conventional tile-based culling, there is no example in which culling is carried out by not expressing an object by a spherical body but an ellipsoidal body. Even though the object is replaced from the spherical body to the ellipsoidal body as it is, computation of cross determination between the ellipsoidal body and the frustum body becomes complicated, thereby increasing the arithmetic amount. Therefore, there is a fear that hindrance occurs in the real-time rendering.

It is an object of at least one of embodiments according to the present invention to solve the problems described above, and to provide a cross determining program, a cross determining method, and a cross determining apparatus capable of carrying out, even though an object defined in a three-dimensional virtual space is an ellipsoidal body, cross determination between the ellipsoidal body and a frustum body in culling at high speed.

According to one non-limiting aspect of the present invention, there is provided a non-transitory computer-readable medium including a cross determining program for causing a computer to execute processes to divide a drawing screen into a plurality of frustum bodies and determine whether each of the frustum bodies crosses an object defined and arranged in a three-dimensional virtual space or not. In this case, the cross determining program causes the computer to determine whether the object influences on a drawing point of the drawing screen to carry out culling.

The processes include a frustum body coordinate obtaining process configured to obtain a spatial coordinate of a frustum body as one determination target.

The processes also include an object coordinate obtaining process configured to obtain a spatial coordinate of an object as another determination target.

The processes also include an expansion/contraction process configured to expand and contract, in a case where a shape of the object is an ellipsoidal body, a space in which the frustum body and the ellipsoidal body are arranged so that the ellipsoidal body becomes a spherical body with respect to the whole space in which a point of view is used as an origin.

The processes also include a cross determining process configured to carry out cross determination between the spherical body and the frustum body by using coordinate information of the spherical body after the expansion/contraction process and coordinate information of the frustum body after the expansion/contraction process to output a determination result.

According to another non-limiting aspect of the present invention, there is provided a cross determining method of dividing a drawing screen into a plurality of frustum bodies and determining whether each of the frustum bodies crosses an object defined and arranged in a three-dimensional virtual space or not in order to determine whether the object influences on a drawing point of the drawing screen to carry out culling.

The cross determining method includes a frustum body coordinate obtaining step of obtaining a spatial coordinate of a frustum body as one determination target.

The cross determining method also includes an object coordinate obtaining step of obtaining a spatial coordinate of an object as another determination target.

The cross determining method also includes an expansion/contraction step of expanding and contracting, in a case where a shape of the object is an ellipsoidal body, a space in which the frustum body and the ellipsoidal body are arranged so that the ellipsoidal body becomes a spherical body with respect to the whole space in which a point of view is used as an origin.

The cross determining method also includes a cross determining step of carry out cross determination between the spherical body and the frustum body by using coordinate information of the spherical body after the expansion/contraction step and coordinate information of the frustum body after the expansion/contraction step to output a determination result.

According to still another non-limiting aspect of the present invention, there is provided a cross determining apparatus configured to divide a drawing screen into a plurality of frustum bodies and determine whether each of the frustum bodies crosses an object defined and arranged in a three-dimensional virtual space or not in order to determine whether the object influences on a drawing point of the drawing screen to carry out culling.

The cross determining apparatus includes a frustum body coordinate obtaining unit configured to obtain a spatial coordinate of a frustum body as one determination target.

The cross determining apparatus also includes an object coordinate obtaining unit configured to obtain a spatial coordinate of an object as another determination target.

The cross determining apparatus also includes an expansion/contraction unit configured to expand and contract, in a case where a shape of the object is an ellipsoidal body, a space in which the frustum body and the ellipsoidal body are arranged so that the ellipsoidal body becomes a spherical body with respect to the whole space in which a point of view is used as an origin.

The cross determining apparatus also includes a cross determining unit configured to carry out cross determination between the spherical body and the frustum body by using coordinate information of the spherical body after expansion and contraction by the expansion/contraction unit and coordinate information of the frustum body after the expansion and contraction to output a determination result.

According to each of the embodiments of the present application, one or two or more shortages are solved.

### BRIEF DESCRIPTION OF THE DRAWINGS

The foregoing and other objects, features and advantages of the present invention will become more readily apparent from the following detailed description of preferred embodiments of the present invention that proceeds with reference to the appending drawings:

FIG. 1 is a block diagram showing an example of a configuration of a cross determining apparatus corresponding to at least one of embodiments according to the present invention.

FIG. 2 is a flowchart showing an example of cross determining processing corresponding to at least one of the embodiments according to the present invention.

FIG. 3 is a plan view showing one example of arrangement of a frustum body and an ellipsoidal body in a case where an object is the ellipsoidal body.

FIG. 4 is a plan view showing a frustum body and a spherical body in a case where expansion/contraction processing is carried out for the frustum body and the ellipsoidal body shown in FIG. 3.

FIG. 5 is a plan view showing a frustum body and a spherical body in a case where rotation processing is carried out for the frustum body and the ellipsoidal body shown in FIG. 4.

FIG. 6 is a block diagram showing an example of a configuration of a cross determining apparatus corresponding to at least one of the embodiments according to the present invention.

FIG. 7 is a flowchart showing an example of cross determining processing corresponding to at least one of the embodiments according to the present invention.

FIG. 8 is a plan view showing a state where an Axis-Aligned Bounding Box is set to the frustum body and the spherical body shown in FIG. 4, which shows a state after the expansion/contraction processing was carried out for the ellipsoidal body.

FIG. 9. is a plan view showing a state where an Axis-Aligned Bounding Box is set to the frustum body and the spherical body shown in FIG. 5, which shows a state after the rotation processing was carried out.

### DETAILED DESCRIPTION OF THE INVENTION

Hereinafter, examples of embodiments according to the present invention will be described with reference to the drawings. In this regard, various kinds of elements in an example of each embodiment, which will be described below, can appropriately be combined with each other in a range where contradiction or the like did not occur. Further, explanation of the content that will be described as an example of an embodiment may be omitted in another embodiment. Further, the content of operations and/or processing with no relationship to characteristic portions of each embodiment may be omitted. Moreover, various kinds of processing that constitute various kinds of processing flows (will be described below) may be carried out in random order in a range where contradiction or the like did not occur in the content of the processing.

### First Embodiment

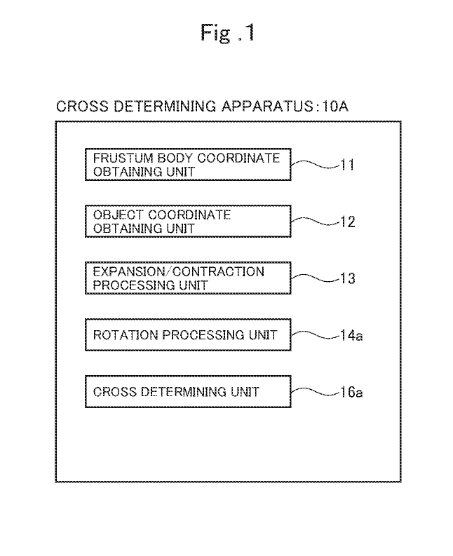

FIG. 1 is a block diagram showing an example of a configuration of a cross determining apparatus 10A according to one embodiment of the present invention. The cross determining apparatus 10A shown in FIG. 1 may be an apparatus designed as a dedicated machine, but it is one that can be realized by a general computer. In this case, the cross determining apparatus 10A includes a CPU (Central Processing Unit), a GPU (Graphics Processing Unit), a memory, and a storage such as a hard disk drive, with which a generic computer is normally provided (not shown in the drawings). Further, it goes without saying that various kinds of processes are carried out by programs for causing this generic computer to function as the cross determining apparatus 10A according to the present embodiment.

The cross determining apparatus 10A according to the present invention is applied to cross determining processing between a frustum body and an object. The frustum body corresponds to tiles in tile-based culling in which a drawing screen is divided into a plurality of tiles to carry out a process of culling. Here, the cross determining processing means a process to determine whether a portion in which the frustum body and an influence range of the object overlap exists or not. In this regard, the cross determining processing is not limited to the tile-based culling. Any method can similarly be applied so long as the process is carried out by dividing a three-dimensional virtual space into predetermined unit regions. For example, the present invention can also be applied to clustered shading in which a process to divide a three-dimensional virtual space further finely is carried out. Further, the object for which culling is to be carried out may be any object. Hereinafter, light culling in a case where the object is a light source will be descried as an example.

In a case where a plurality of light sources exists in a three-dimensional virtual space, it is ideal to calculate influence from the plurality of light sources for each drawing point. However, an arithmetic amount thereof becomes huge. For this reason, the drawing screen is divided into the plurality of tiles (rectangles) each of which a plurality of drawing points is unified, and a frustum body is set to each tile. It is determined whether influence from the light source as the object is to be computed at the time of computation of each drawing point in the tile on the basis of whether the frustum body crosses the light source or not. A size and coordinate positions of a front surface and a size and coordinate positions of a bottom surface in the frustum body, which are set so as to correspond to the tile from depth information of each drawing point of the tile, are determined. For this reason, a shape of the frustum body is defined. In a case where the plurality of light sources is arranged in the three-dimensional virtual space, a bounding volume is set in order to determine the influence range of each light source. The cross determination between each of the frustum bodies and each of the light sources as all objects that exist in the three-dimensional virtual space is carried out. As for the crossed light source, it is determined that there is a possibility to influence on the drawing point of the frustum body. The amount of influence from the light source is computed for each drawing point accurately. Namely, in order to determine whether there is necessary to calculate the influence on the drawing point from the light source or not, the cross determination between the light source and the frustum body is carried out. Conventionally, a spherical body has been used as the bounding volume. However, the present invention has a feature in cross determination in a case where an ellipsoidal body is applied as the bounding volume.

As shown in FIG. 1, the cross determining apparatus 10A includes a frustum body coordinate obtaining unit 11, an object coordinate obtaining unit 12, an expansion/contraction processing unit 13, a rotation processing unit 14a, and a cross determining unit 16a.

The frustum body coordinate obtaining unit 11 has a function to obtain a spatial coordinate of the frustum body as one determination target. The frustum body is a truncated pyramid that has a top surface composed of a quadrangle perpendicular to a Z axis, which is an axis in a depth direction of a space and a bottom surface composed of a quadrangle perpendicular to the Z axis. A position of the frustum body is determined by four coordinate positions of the top surface and four coordinate positions of the bottom surface.

The object coordinate obtaining unit 12 has a function to obtain a spatial coordinate of an object as another determination target. In a case where the object is a spherical body, a position of the object is decided by information on a central coordinate and a radius thereof. In a case where the object is an ellipsoidal body, a position of the object is decided by information on a central coordinate, directions of three axes, and semidiameter (or semi-axis) thereof a, b, c.

The expansion/contraction processing unit 13 has a function to expand or contract, in a case where a shape of the object is the ellipsoidal body, a space in which the frustum body and the ellipsoidal body are arranged so that the ellipsoidal body becomes a spherical body with respect to the whole space in which a point of view is used as an origin. In a case where lengths of three axes in the ellipsoidal body are different from each other, the expansion/contraction processing unit 13 expands and contracts the whole space in which the frustum body and the ellipsoidal body are arranged so that all the axes have the same length, whereby the ellipsoidal body is converted into the spherical body. By expanding and contracting the whole space including the frustum body at the same rate, the spherical body and the frustum body are respectively changed into deformed ones without destroying a positional relationship between the ellipsoidal body and the frustum body. Further preferably, by carrying out the expansion/contraction processing so that a radius of the spherical body becomes one, it becomes possible to carry out computation of the cross determining processing thereafter more easily.

The rotation processing unit 14a has a function to cause the frustum body and the spherical body to rotate so that a bottom surface of the frustum body becomes perpendicular to an axis in a computational depth direction with respect to the spherical body and the frustum body after the expansion/contraction processing. In order to facilitate arithmetic processing of the cross determination, the rotation processing unit 14a carries out rotation processing so that the bottom surface of the frustum body becomes perpendicular to the axis (Z axis) in the depth direction, that is, becomes parallel to an X-Y plane.

The cross determining unit 16a has a function to carry out cross determination between the spherical body and the frustum body by using coordinate information of the spherical body and coordinate information of the frustum body to output a determination result. In the cross determination, the cross determining unit 16a determines whether each surface of the frustum body crosses the spherical body or not. In a case where it is determined that any one surface of the frustum body crosses the spherical body, the cross determining unit 16a determines that the frustum body crosses the spherical body. A method of the cross determination may be any method. For example, it is thought that the cross determination is carried out by using a distance of the surface in a vertical direction, and determination regarding a boundary of the surface is omitted. Namely, when in each surface, it is set that “N” is a normal vector, “O” is an arbitrary point on the surface, “C” is a center of the spherical body, and “R” is a radius of the spherical body, a vector from the arbitrary point “O” to the center of the spherical body on the surface is represented by (C−O). When an inner product between this vector and the normal vector N is computed, a distance from the arbitrary point “O” on the surface in a normal direction is obtained. In a case where the distance from the arbitrary point “O” on the surface in the normal direction is smaller than a radius R of the spherical body, it is determined that the frustum body crosses the spherical body. Namely, rough cross determination is carried out in which it should be deemed that the frustum body crosses the spherical body in a case where any one of the arbitrary points on the surface satisfies a formula {N×(C−O)}<R (hereinafter, referred to as a “cross determining formula”). This cross determining formula between the spherical body and the surface is a conventionally known method.

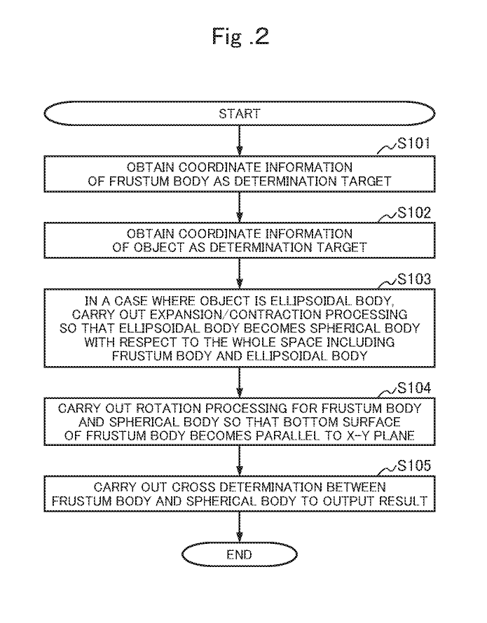

Next, a flow of the cross determining processing carried out by the cross determining apparatus 10A according to the present embodiment will be described. FIG. 2 is a flowchart showing an example of cross determining processing corresponding to at least one of the embodiments according to the present invention. As shown in FIG. 2, in the cross determining processing, the frustum body coordinate obtaining unit 11 first obtains coordinate information of a frustum body, which is one determination target of cross determination, in a three-dimensional virtual space (Step S101). Subsequently, the object coordinate obtaining unit 12 obtains coordinate information of an object, which is another determination target of the cross determination, in the three-dimensional virtual space (Step S102).

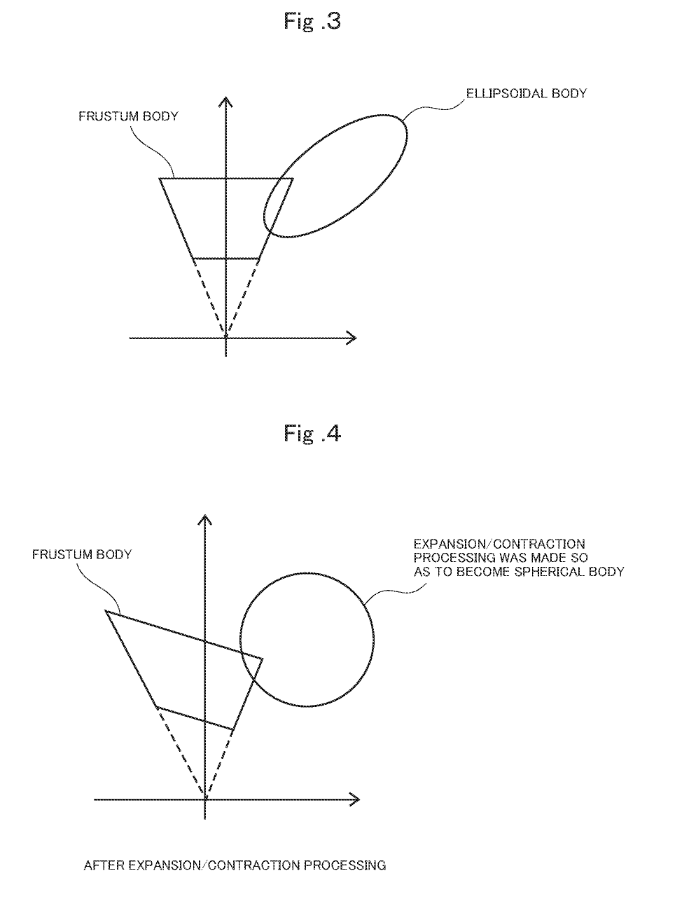

In a case where the object is an ellipsoidal body, the expansion/contraction processing unit 13 carries out expansion/contraction processing so that the ellipsoidal body becomes a spherical body with respect to the whole space in which the frustum body and the ellipsoidal body are arranged (Step S103). FIG. 3 is a plan view showing one example of arrangement of the frustum body and the ellipsoidal body in a case where the object is the ellipsoidal body. In this situation shown in FIG. 3, the cross determination cannot be carried out by using the cross determining formula described above as it is. Thus, as shown in FIG. 3, the expansion/contraction processing is carried out for the whole space in which the frustum body and the ellipsoidal body are arranged, thereby converting the ellipsoidal body into the spherical body. FIG. 4 is a plan view showing the frustum body and the spherical body in a case where the expansion/contraction processing is carried out for the frustum body and the ellipsoidal body shown in FIG. 3. It can be said that a cross relationship between the frustum body and the ellipsoidal body does not change so long as the expansion/contraction processing is carried out for the whole space because the cross relationship between the frustum body and the spherical body is taken over after the expansion/contraction processing. If the ellipsoidal body can be converted into the spherical body by carrying out the expansion/contraction processing, it becomes possible to carry out the cross determination by using the cross determining formula described above. In this regard, in a case where the object is the spherical body, the object is an ellipsoidal body that satisfies a condition of a=b=c for the semidiameters from the beginning. For this reason, the processing flow merely shifts to a next Step without carrying out the expansion/contraction processing.

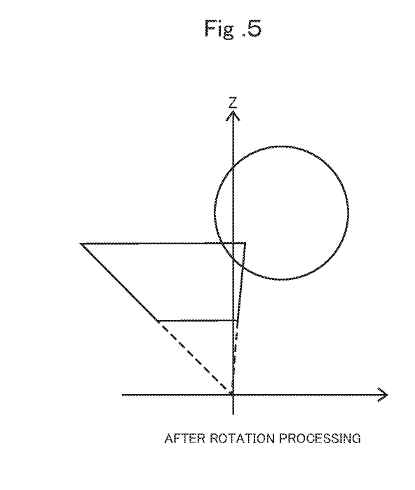

After the expansion/contraction processing, the rotation processing unit 14a carries out rotation processing in which the frustum body and the spherical body are caused to rotate around the point of view so that a bottom surface of the frustum body becomes perpendicular to an axis (Z axis) in a computational depth direction, that is, becomes parallel to an X-Y plane (Step S104). FIG. 5 is a plan view showing the frustum body and the spherical body in a case where the rotation processing is carried out for the frustum body and the ellipsoidal body shown in FIG. 4. Cross determining processing is also possible in the state of the frustum body shown in FIG. 4 after the expansion/contraction processing. However, as shown in FIG. 5, by carrying out the rotation processing so that the bottom surface of the frustum body becomes perpendicular to the Z axis, it is possible to reduce an arithmetic amount at the time of the cross determination. This is because there is necessary to calculate a distance between each surface of the frustum body and a sphere in order to carry out the cross determination between the frustum body and the spherical body. As explained for the cross determining formula described above, it is calculated by an inner product between the normal line of each surface and the center of the sphere. In this case, if a depth surface is perpendicular to the Z axis, with respect to the top surface and the bottom surface of the frustum body, calculation of the distance can be replaced simply by a distance in a Z axis direction without carrying out the normal line and/or the inner product. Therefore, it is possible to make a calculation amount smaller.

Finally, the cross determining unit 16a carries out the cross determination between the frustum body and the spherical body to output a determination result (Step S105), and the cross determining apparatus 10A terminates the cross determining processing herein. In a case where a plurality of objects is defined in the three-dimensional virtual space, the cross determining unit 16a carries out the cross determining processing with each of the objects. When the cross determining processing with each of all the objects is terminated, an influence of the object on each of the drawing points in the frustum body is computed in detail. However, at that time, detailed computation with only an object that it is determined to cross the spherical body is carried out.

As described above, according to the cross determining apparatus 10A of the present embodiment, even in a case where the object is the ellipsoidal body, it is possible to apply a known cross determining formula by carrying out the expansion/contraction processing. Further, by carrying out the rotation processing, the top surface and the bottom surface of the frustum body become the Z axis, it becomes possible to carry out the cross determination simply using the distance in the Z axis direction. For this reason, it becomes possible to reduce the arithmetic amount. Namely, even though the ellipsoidal body is applied as the object, it is possible to carry out the cross determining processing at high speed. Therefore, it also becomes possible to carry out the cross determination in real-time rendering appropriately.

### Second Embodiment

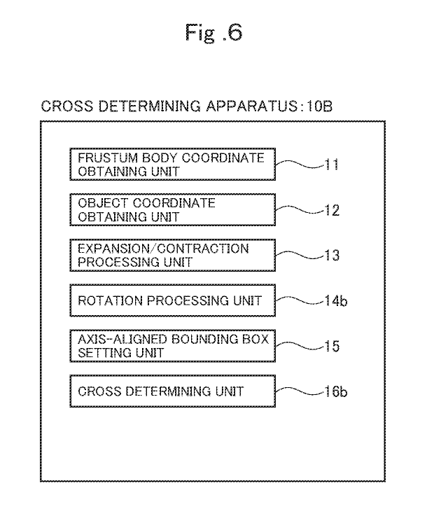

FIG. 6 is a block diagram showing an example of a configuration of a cross determining apparatus 10B according to one embodiment of the present invention. In this regard, the same reference numeral is assigned to the similar constituent portion as that in the cross determining apparatus 10A according to the first embodiment, and its explanation will be omitted. Further, the cross determining apparatus 10B shown in FIG. 6 may be an apparatus designed as a dedicated machine, but it is one that can be realized by a generic computer. These points are also similar to those in the first embodiment.

The rotation processing unit 14b has a function to rotate a frustum body and a spherical body so that a bottom surface of the frustum body becomes perpendicular to an axis in a computational depth direction with respect to the spherical body and the frustum body after expansion/contraction processing. In order to facilitate arithmetic processing of cross determination, the rotation processing unit 14b carries out rotation processing so that the bottom surface of the frustum body becomes perpendicular to the axis in the depth direction (Z axis), that is, becomes parallel to an X-Y plane. Further, the rotation processing unit 14b has a function to rotate the frustum body and the spherical body so that any one side constituting the bottom surface of the frustum body becomes parallel to a vertical axis or a horizontal axis in a plane perpendicular to the axis in the depth direction. Namely, the rotation processing unit 14b carries out the rotation processing so that one side constituting the bottom surface of the frustum body becomes parallel to an X axis or a Y axis of the X-Y plane.

An axis-aligned bounding box setting unit 15 has a function to set an Axis-Aligned Bounding Box that includes the frustum body. Here, the Axis-Aligned Bounding Box (AABB) is also referred to as a “rectangular box”. The Axis-Aligned Bounding Box is a rectangular parallelepiped formed only by a surface parallel to the X-Y plane, a surface parallel to an X-Z plane, and a surface parallel to a Y-Z plane. The Axis-Aligned Bounding Box is a rectangular parallelepiped whose size is set so as to include the frustum body. There is necessary that the frustum body does not protrude from, but is included in the Axis-Aligned Bounding Box. Thus, it is preferable that it has the minimum size among rectangular parallelepipeds each of which satisfies a condition.

A cross determining unit 16b has a function to carry out cross determination between the spherical body and the Axis-Aligned Bounding Box by using coordinate information of the spherical body and coordinate information of the Axis-Aligned Bounding Box to output a determination result. A method of the cross determination may be any method, but is one using the cross determining formula described above, for example. Further, by using a determining method described in Non-Patent Document 1 as the method of the cross determination, it is possible to calculate the cross determination at high speed compared with the case of cross determination between each surface and a sphere.

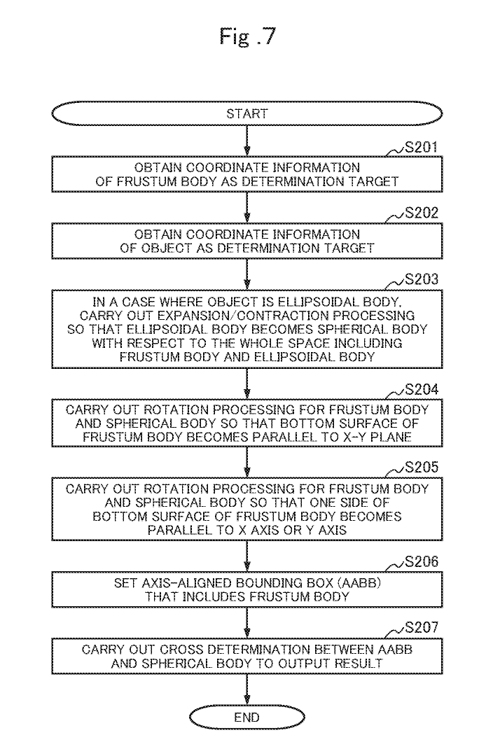

Next, a flow of the cross determining processing carried out by the cross determining apparatus 10B according to the present embodiment will be described. FIG. 7 is a flowchart showing an example of the cross determining processing according to at least one of the embodiments of the present invention. As shown in FIG. 7, in the cross determining processing, the frustum body coordinate obtaining unit 11 first obtains coordinate information of a frustum body, which is one determination target of cross determination, in a three-dimensional virtual space (Step S201). Subsequently, the object coordinate obtaining unit 12 obtains coordinate information of an object, which is another determination target of the cross determination, in the three-dimensional virtual space (Step S202).

In a case where the object is an ellipsoidal body, the expansion/contraction processing unit 13 carries out expansion/contraction processing so that the ellipsoidal body becomes a spherical body with respect to the whole space in which the frustum body and the ellipsoidal body are arranged (Step S203). It can be said that a cross relationship between the frustum body and the ellipsoidal body does not change so long as the expansion/contraction processing is carried out for the whole space because the cross relationship between the frustum body and the spherical body is taken over after the expansion/contraction processing. After the expansion/contraction processing, the rotation processing unit 14b carries out rotation processing in which the frustum body and the spherical body are caused to rotate around the point of view so that a bottom surface of the frustum body becomes perpendicular to an axis (Z axis) in a computational depth direction, that is, becomes parallel to an X-Y plane (Step S204). Moreover, the rotation processing unit 14b carries out rotation processing in which the frustum body and the spherical body are caused to rotate around the point of view so that one side of the bottom surface of the frustum body becomes parallel to the X axis or the Y axis (Step S205). The axis-aligned bounding box setting unit 15 then sets an Axis-Aligned Bounding Box that includes the frustum body after the rotation processing (Step S206). Finally, the cross determining unit 16b carries out the cross determination between the Axis-Aligned Bounding Box and the spherical body to output a determination result (Step S207), and the cross determining apparatus 10B terminates the cross determining processing. In a case where a plurality of objects is defined in the three-dimensional virtual space, the cross determining unit 16a carries out the cross determining processing with each of the objects. When the cross determining processing with each of all the objects is terminated, an influence of the object on each of the drawing points in the frustum body is computed in detail. However, at that time, detailed computation with only an object that it is determined to cross the spherical body is carried out.

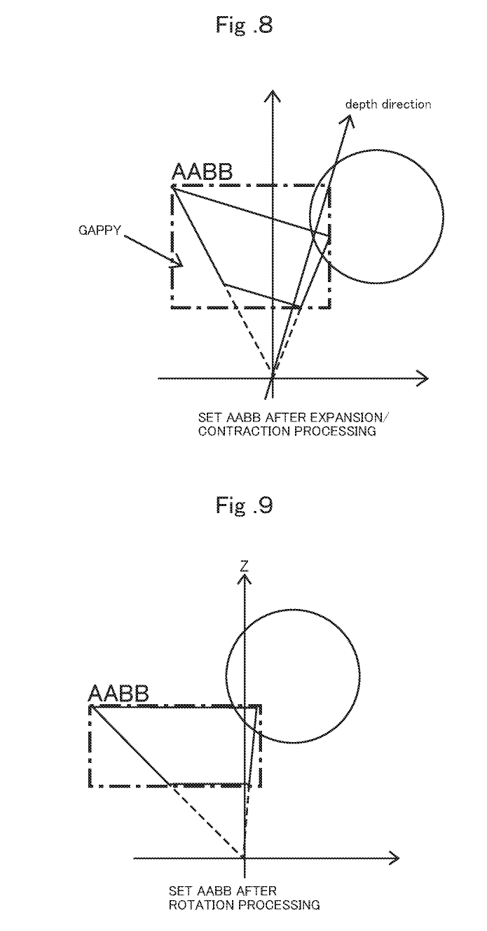

As described in Non-Patent Document 1, a method of setting an Axis-Aligned Bounding Box to carry out cross determination has been carried out conventionally, and it is useful in that an arithmetic amount thereof can be reduced further. Here, FIG. 8 is a plan view showing a state where the Axis-Aligned Bounding Box is set to the frustum body and the spherical body shown in FIG. 4, which shows a state after the expansion/contraction processing was carried out for the ellipsoidal body. Even in a case where the Axis-Aligned Bounding Box is set to the frustum body and the spherical body after the expansion/contraction processing as shown in FIG. 8, the effect to reduce the arithmetic amount can be expected. However, the frustum body, which is the original determination target, is deformed by the expansion/contraction processing. For this reason, in a case where the Axis-Aligned Bounding Box is set so as to include the deformed frustum body, it cannot choose but set the Axis-Aligned Bounding Box with a larger volume compared with the original frustum body, as shown in FIG. 8. In this case, there is a problem that it becomes increasingly likely to generate a mistake in determination so-called “false-positive”. The false-positive means a situation that it is determined that the spherical body crosses the Axis-Aligned Bounding Box, but the spherical body does not cross the original frustum body.

Thus, in the present embodiment, after the expansion/contraction processing, the rotation processing is carried out in which the frustum body and the spherical body are rotated around the point of view so that the bottom surface of the frustum body becomes perpendicular to the axis (Z axis) in the computational depth direction, that is, becomes parallel to the X-Y plane, and the frustum body and the spherical body is further rotated around the point of view so that one side of the bottom surface of the frustum body becomes parallel to the X axis or the Y axis. FIG. 9 is a plan view showing a state where an Axis-Aligned Bounding Box is set to the frustum body and the spherical body shown in FIG. 5, which shows a state after the rotation processing was carried out. As shown in FIG. 9, by carrying out the rotation processing and then setting the Axis-Aligned Bounding Box, it is possible to make a volume difference between the frustum body and the Axis-Aligned Bounding Box smaller. For this reason, it becomes possible to reduce a possibility that it is determined as false-positive. Further, by making the bottom surface of the frustum body perpendicular to the Z axis in a constructing process of the AABB, it is possible to suppress a calculation amount for a process of obtaining a boundary of a Z axis direction. This is because there is no need to check all of eight apexes in order to check the boundary of the Z axis and it becomes possible to use a depth between a top surface and the bottom surface in place of the apexes.

As described above, according to the cross determining apparatus 10B of the present embodiment, even in a case where the object is the ellipsoidal body, by carrying out the expansion/contraction processing, it is converted into a relationship of the cross determination between the known spherical body and the frustum body, the Axis-Aligned Bounding Box is set to the frustum body, and the cross determining processing between the Axis-Aligned Bounding Box and the spherical body is carried out. Therefore, it becomes possible to reduce an arithmetic amount. Further, by carrying out the rotation processing after the expansion/contraction processing and then setting the Axis-Aligned Bounding Box, it is possible to make a volume difference between the frustum body and the Axis-Aligned Bounding Box smaller, and this makes it possible to reduce a possibility that it is determined as false-positive. Further, this rotation processing allows a calculation amount regarding construction of the Axis-Aligned Bounding Box to be reduced.

As explained above, one or two or more shortages can be solved by each of the embodiments according to the present application. In this regard, the effects by each of the embodiments are non-limiting effects or one example of the non-limiting effects.

According to one of the embodiments of the present invention, even though an ellipsoidal body is adopted as expression of an influence range of an object defined in a three-dimensional virtual space in a graphics drawing field, it becomes possible to carry out cross determination for which an arithmetic amount is reduced. For this reason, it is possible to carry out more suitable image expression by increasing expression methods using an ellipsoidal body in various kinds of graphics drawing.

What is claimed is:

1. A non-transitory computer-readable medium including a cross determining program for causing a computer to execute processes to divide a drawing screen into a plurality of frustum bodies and determine whether each of the frustum bodies crosses an object defined and arranged in a three-dimensional virtual space or not, the cross determining program causing the computer to determine whether the object influences on a drawing point of the drawing screen to carry out culling,
wherein the processes include:
a frustum body coordinate obtaining process configured to obtain a spatial coordinate of a frustum body as one determination target;
an object coordinate obtaining process configured to obtain a spatial coordinate of an object as another determination target;
an expansion/contraction process configured to expand and contract, in a case where a shape of the object is an ellipsoidal body, a space in which the frustum body and the ellipsoidal body are arranged so that the ellipsoidal body becomes a spherical body with respect to the whole space in which a point of view is used as an origin; and
a cross determining process configured to carryout cross determination between the spherical body and the frustum body by using coordinate information of the spherical body after the expansion/contraction process and coordinate information of the frustum body after the expansion/contraction process to output a determination result.

2. The non-transitory computer-readable medium according to claim 1,
wherein the cross determining process is executed after executing a rotation process configured to rotate the frustum body and the spherical body around the point of view so that a bottom surface of the frustum body becomes perpendicular to an axis in a computational depth direction after the expansion/contraction process.

3. The non-transitory computer-readable medium according to claim 2,
wherein in the rotation process, the frustum body and the spherical body are rotated around the point of view so that any one side constituting the bottom surface of the frustum body becomes parallel to a vertical axis or a horizontal axis in a plane perpendicular to the axis in the depth direction.

4. A non-transitory computer-readable medium including a cross determining program for causing a computer to execute processes to divide a drawing screen into a plurality of frustum bodies and determine whether each of the frustum bodies crosses an object defined and arranged in a three-dimensional virtual space or not, the cross determining program causing the computer to determine whether the object influences on a drawing point of the drawing screen to carry out culling,
wherein the processes include:
a frustum body coordinate obtaining process configured to obtain a spatial coordinate of a frustum body as one determination target;
an object coordinate obtaining process configured to obtain a spatial coordinate of an object as another determination target;
an expansion/contraction process configured to expand and contract, in a case where a shape of the object is an ellipsoidal body, a space in which the frustum body and the ellipsoidal body are arranged so that the ellipsoidal body becomes a spherical body with respect to the whole space in which a point of view is used as an origin;
an axis-aligned bounding box setting process configured to set an Axis-Aligned Bounding Box that includes the frustum body; and
a cross determining process configured to carryout cross determination between the spherical body and the Axis-Aligned Bounding Box by using coordinate information of the spherical body after the expansion/contraction process and coordinate information of the Axis-Aligned Bounding Box to output a determination result.

5. The non-transitory computer-readable medium according to claim 4,
wherein the axis-aligned bounding box setting process is executed after executing a rotation process configured to rotate the frustum body and the spherical body around the point of view so that a bottom surface of the frustum body becomes perpendicular to an axis in a computational depth direction after the expansion/contraction process.

6. The non-transitory computer-readable medium according to claim 5,
wherein in the rotation process, the frustum body and the spherical body are rotated around the point of view so that any one side constituting the bottom surface of the frustum body becomes parallel to a vertical axis or a horizontal axis in a plane perpendicular to the axis in the depth direction.

7. A cross determining method of dividing a drawing screen into a plurality of frustum bodies and determining whether each of the frustum bodies crosses an object defined and arranged in a three-dimensional virtual space or not in order to determine whether the object influences on a drawing point of the drawing screen to carry out culling, the cross determining method comprising:
a frustum body coordinate obtaining step of obtaining a spatial coordinate of a frustum body as one determination target;
an object coordinate obtaining step of obtaining a spatial coordinate of an object as another determination target;
an expansion/contraction step of expanding and contracting, in a case where a shape of the object is an ellipsoidal body, a space in which the frustum body and the ellipsoidal body are arranged so that the ellipsoidal body becomes a spherical body with respect to the whole space in which a point of view is used as an origin; and
a cross determining step of carry out cross determination between the spherical body and the frustum body by using coordinate information of the spherical body after the expansion/contraction step and coordinate information of the frustum body after the expansion/contraction step to output a determination result.

8. A cross determining apparatus configured to divide a drawing screen into a plurality of frustum bodies and determine whether each of the frustum bodies crosses an object defined and arranged in a three-dimensional virtual space or not in order to determine whether the object influences on a drawing point of the drawing screen to carry out culling, the cross determining apparatus comprising:
a frustum body coordinate obtaining unit configured to obtain a spatial coordinate of a frustum body as one determination target;
an object coordinate obtaining unit configured to obtain a spatial coordinate of an object as another determination target;
an expansion/contraction unit configured to expand and contract, in a case where a shape of the object is an ellipsoidal body, a space in which the frustum body and the ellipsoidal body are arranged so that the ellipsoidal body becomes a spherical body with respect to the whole space in which a point of view is used as an origin; and
a cross determining unit configured to carry out cross determination between the spherical body and the frustum body by using coordinate information of the spherical body after expansion and contraction by the expansion/contraction unit and coordinate information of the frustum body after the expansion and contraction to output a determination result.
